(19) United States
(12) Patent Application Publication
(10) Pub. No.: US 2016/0140034 A1
(43) Pub. Date: May 19, 2016

(54) DEVICES AND METHODS FOR LINKED LIST ARRAY HARDWARE IMPLEMENTATION

(71) Applicant: Samsung Electronics Co., Ltd., Suwon-Si (KR)

(72) Inventor: Gil MEYUHAS, Ramat Gan (IL)

(21) Appl. No.: 14/540,599

(22) Filed: Nov. 13, 2014

(51) Int. Cl. G06F 12/02

(52) U.S. Cl. CPC G06F 12/023

(57) ABSTRACT

A device includes at least one memory including plurality of storage nodes arranged into a plurality of rows. Each of the rows has a known row width. The device includes a controller configured to determine size information regarding a size of at least a first sequence of data elements, and determine location information regarding a location of unused storage nodes in the at least one memory. The controller is configured to write the first sequence of data elements to the at least one memory based on the determined size information and the determined location information such that the first row contains no more than one pointer element for the first sequence of data elements. The pointer element links two sequential data elements.

### BACKGROUND

A linked list is a type of data structure consisting of one or more sets of sequential data elements. In a conventional linked list, each data element in a sequence is stored in a node that includes a field for storing the data element and a field for storing a reference (or pointer) element. For a particular node, the data element contains the information that is desired to be stored and the reference element links the data element to a next data element (in another node) of the sequence. The linked list data structure allows for insertion or removal of data elements from any position in the sequence without reallocation or reorganization of the entire structure. As such, linked lists are useful for linearly organized data (e.g., record keeping applications). However, conventional linked lists do not allow for random access to data and there are latency issues because the sequence of data elements is not stored in a contiguous fashion. Further, conventional linked lists result in increased memory usage due to the presence of the pointer elements.

An array is another type of data structure in which a collection of data elements are stored in a two-dimensional or three-dimensional grid where each data element is identified by an index or a key. The size of the array may be dynamic or fixed and the data elements may be stored so that a position of each data element can be found using the index or the key. As such, the array data structure may allow for random access to data. However, if the memory space reserved for an array is exceeded, the data elements of the entire array may be subject to costly copy and relocate operations.

### SUMMARY

One or more example embodiments relate to devices and/or methods for implementing data structures, and more particularly to devices and/or methods for implementing a linked list with an array type hardware structure. At least one example embodiment provides a linked list data structure that allows for insertion, removal, and/or manipulations of data elements, from any position in a sequence, without reallocation of the data structure. Thus, at least one example embodiment provides a linked list data structure with random accessibility, reduced (or minimum) access/manipulation latency, and throughput that is advantageous for hardware circuits.

According to at least one example embodiment, a device includes at least one memory including plurality of storage nodes arranged into a plurality of rows, each of the rows having a known row width. The device includes a controller configured to determine size information regarding a size of at least a first sequence of data elements and determine location information regarding a location of unused storage nodes in the at least one memory. The controller is configured to write the first sequence of data elements to at least a first row of the at least one memory based on at least one of the determined size information and the determined location information such that the first row contains no more than one pointer element for the first sequence of data elements, the pointer element linking two sequential data elements.

According to at least one example embodiment, the determined location information indicates that the first row is unused.

According to at least one example embodiment, if the determined size information indicates that a size of the first sequence of data elements exceeds a threshold associated with a storage capacity of the first row, then the controller is configured to write data elements of the first sequence that precede the pointer element and the pointer element to the first row and write remaining data elements of the first sequence that follow the pointer to a second row of the at least one memory.

According to at least one example embodiment, the determined location information indicates that the first row and the second row are unused.

According to at least one example embodiment, wherein the at least one memory includes a first memory and a second memory, the first memory having the first row. If the determined size information indicates that a size of the first sequence of data elements exceeds a threshold associated with a storage capacity of the first row of the first memory, the controller is configured to write data elements of the first sequence that precede the pointer element and the pointer element to the first row of the first memory and write remaining data elements of the first sequence that follow the pointer to the second memory.

According to at least one example embodiment, the controller is configured to write the remaining data elements of the first sequence to a row the second memory that corresponds to a same numbered row as the row of the first memory.

According to at least one example embodiment, the first memory and the second memory have different known row widths.

According to at least one example embodiment, the at least one memory includes a first memory and a second memory, the first memory having the first row. If the determined size information indicates that a size of the first sequence of data elements exceeds a threshold associated with a storage capacity of the first row of the first memory, the controller is configured to write the first sequence of data elements over a row of the first memory and a row the second memory that corresponds to a same numbered row as the row of the first memory without the use of the pointer element.

According to at least one example embodiment, the controller is configured to perform at least one of a read operation and a search operation related to the first sequence of data elements in a single clock cycle.

According to at least one example embodiment, in order to perform the search operation for a desired data element in the first sequence, the controller is configured to determine whether the first sequence of data elements is stored over multiple rows of the at least one memory based on the determined size information and a known row width of the least one memory, read at least some of the data elements of the first sequence from at least one of the rows, compare the desired element to each of the read data elements, and return a position of the desired element in the first sequence based on the comparison.

According to at least one example embodiment, the at least one memory is at least one random access memory.

According to at least one example embodiment, the device further includes a first register a second register. The controller is configured to store the determined size information for at least the first sequence in the first register, and store the determined location information in the second register.

According to at least one example embodiment, the controller is configured to modify the first sequence of data elements by at least one of inserting an additional data element, deleting an existing data element, and concatenating the first sequence of data elements with a second sequence of data elements.

According to at least one example embodiment, in order to modify the first sequence of data elements by inserting the additional data element, the controller is configured to read the determined size information stored in the first register, determine a remaining storage capacity of the at least one row based on the determined size information read from the first register, generate a modified sequence of data elements by inserting the additional data element into a desired location of the first sequence of data elements based on the determined remaining storage capacity, and write the modified sequence of data elements to the at least one row.

According to at least one example embodiment, the controller is configured to update the first register with size information of the modified sequence.

According to at least one example embodiment, in order to modify the first sequence of data elements by deleting the existing data element, the controller is configured to determine a position of the existing data element in the first sequence, generate a modified sequence of data elements by deleting the existing data element from the first sequence based on the determined position, and write the modified sequence of data elements to the at least one row.

According to at least one example embodiment, the controller is configured to update the first register based on size information of the modified sequence.

According to at least one example embodiment, the controller is configured to store size information of a second sequence of data elements in the first register. In order to modify the first sequence of data elements by concatenating the first sequence of data elements with the second sequence of data elements, the controller is configured to read the size information for each of the first sequence of data elements and the second sequence of data elements from the first register, calculate a combined size of the first sequence and the second sequence as a concatenated sequence of data elements using the size information read from the first register, and write the concatenated sequence of data elements to the at least one row based on the calculated combined size.

According to at least one example embodiment, a system includes the above described device, a system bus, and a host configured to communicate with the device using the system bus.

According to at least one example embodiment, a method includes fabricating the at least one memory based on design parameters. The method includes instructing the controller to determine the size information, determine the location information, and write the first sequence of data elements to at least the first row of the at least one memory.

### BRIEF DESCRIPTION OF THE DRAWINGS

Example embodiments will become more appreciable through the description of the drawings in which:

FIGS. 1-5 are block diagrams illustrating elements of a memory system including a memory device according to at least one example embodiment.

FIGS. 6A-6D show linked list topographies according to at least one example embodiment.

FIG. 7 is a flow chart illustrating the operation of a memory controller according to at least one example embodiment.

FIG. 8 is a flow chart illustrating the details of a writing operation of a memory controller according to at least one example embodiment.

FIGS. 9A-12B illustrate details of performing one or more additional operations on a sequence of data elements according to at least one example embodiment.

### DETAILED DESCRIPTION OF EXAMPLE EMBODIMENTS

Example embodiments will now be described more fully with reference to the accompanying drawings. Many alternate forms may be embodied and example embodiments should not be construed as limited to example embodiments set forth herein. In the drawings, like reference numerals refer to like elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., flash memories (e.g., NAND flash memories), electronic imaging systems, image processing systems, digital point-and-shoot cameras, personal digital assistants (PDAs), smartphones, tablet personal computers (PCs), laptop computers, etc.). Such existing hardware may include one or more Central Processing Units (CPUs), digital signal processors (DSPs), application-specific-integrated-circuits (ASICs), field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible or non-transitory machine readable mediums for storing information. The term “computer-readable medium” may include, but is not limited to, portable or fixed storage devices, optical storage devices, and various other tangible or non-transitory mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

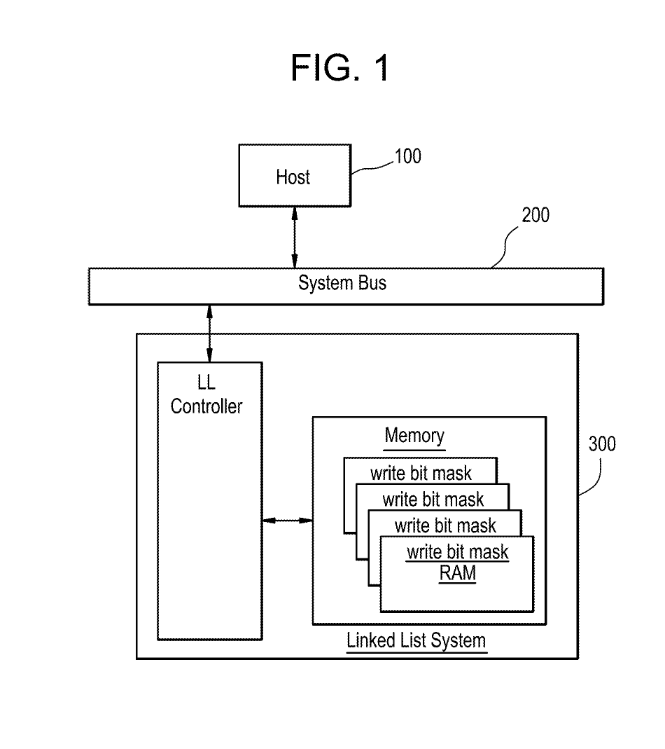

FIGS. 1-5 are block diagrams illustrating elements of a memory system including a memory device according to at least one example embodiment. As shown in FIG. 1 a system 10 may include a host 100 and a linked list system 300. The linked list system 300 and the host 100 may communicate via system bus 200. The host may include a central processing unit (CPU) that controls the operation of the linked list system 300.

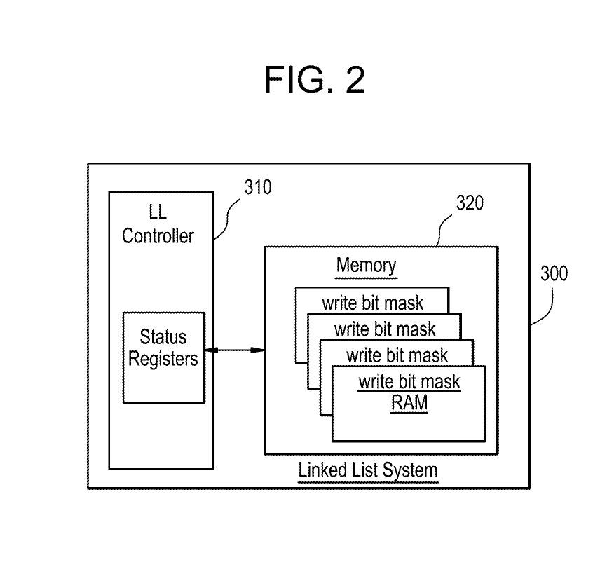

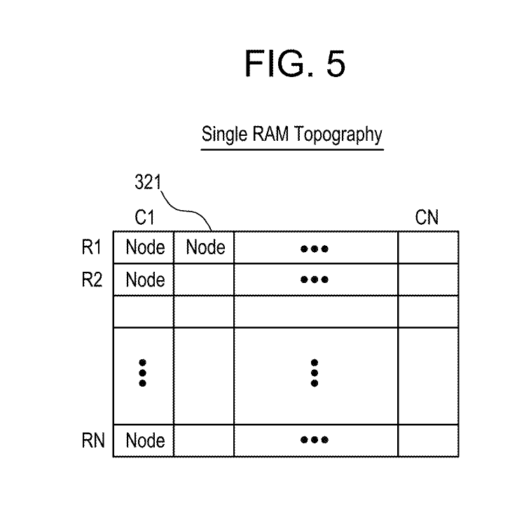

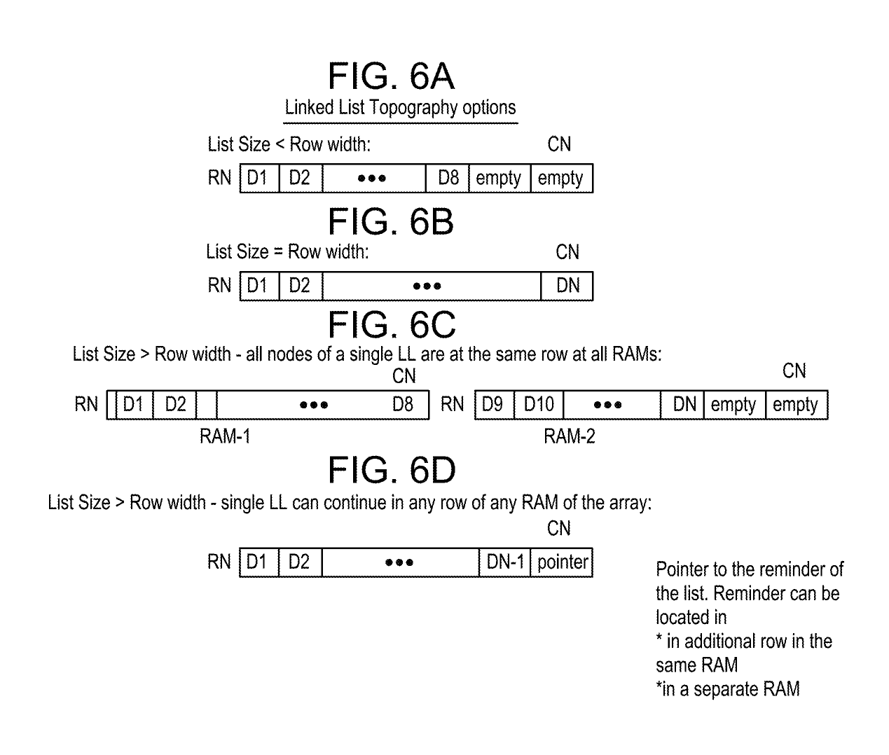

As shown in FIG. 2, the linked list system 300 may include a linked list controller 310, a memory array 320, and a function controller 330. The memory array 320 may include one or more random access memories (RAMs). In at least one example embodiment, the RAMs are write-bit-mask RAMs capable of being controlled to mask off bits to perform bitwise write operations. The structure of each RAM is discussed in more detail with reference to FIG. 5. The linked list controller 310 may control operations for each linked list stored in the memory array 320. For example, the linked list controller 310 may control read and write operations as well as modify operations (e.g., insert, delete, search, and concatenate operations) for the linked lists (also referred to as sequences of data elements) in memory array 320. Linked list topographies and operations of the linked list controller 310 are discussed in further detail with reference to FIGS. 6-12B.

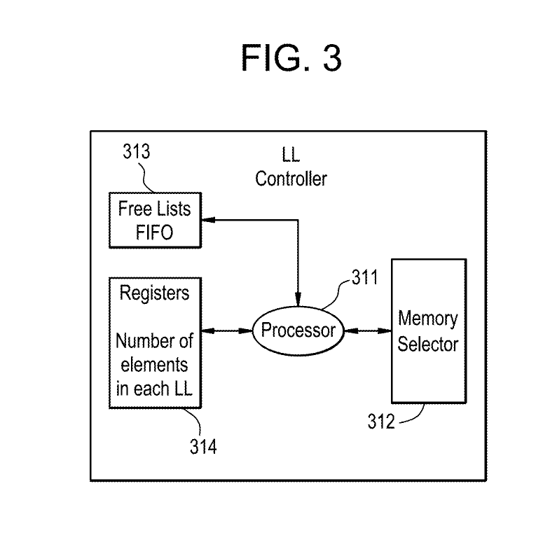

With reference to FIG. 3, the linked list controller 310 may include a processor 311 for performing read and write operations for the linked lists. The memory selector 312 may select a RAM from memory array 320 based on a command from the processor 311. The processor 311 may communicate with and control the content of registers 313 and 314. In at least one example embodiment, register 313 may store location information regarding a location of unused storage nodes within each RAM of the memory array 320. Register 313 may be a first in first out (FIFO) register that records and allocates unused storage nodes using FIFO principles. The registers 313 and 314 may be caching memories for the processor 311. For example, the registers 313 and 314 may be static random access memories (SRAM). In at least one example embodiment, register 314 may store size information regarding a size of each linked list stored on the RAMs in memory array 320. For example, register 314 may store the number of data elements present in each linked list as well as a size of each data element in a list.

It should be understood that a linked list controller according to at least one example embodiment may include registers in addition to or different from registers 313 and 314. For example, the linked list controller 310 may include a register for keeping record of a number of linked lists stored in a RAM 321, a register for holding pointer elements in the event that a linked list exceeds the storage capacity of a memory row, or any other registers that are useful for tracking the location and size of a linked list stored in memory array 320. These other registers may include any register that that contributes to accessing a linked list that is spread over more than one RAM row so that all the elements of the linked list could be accessed and manipulated in the same (or fewer) clock cycle(s).

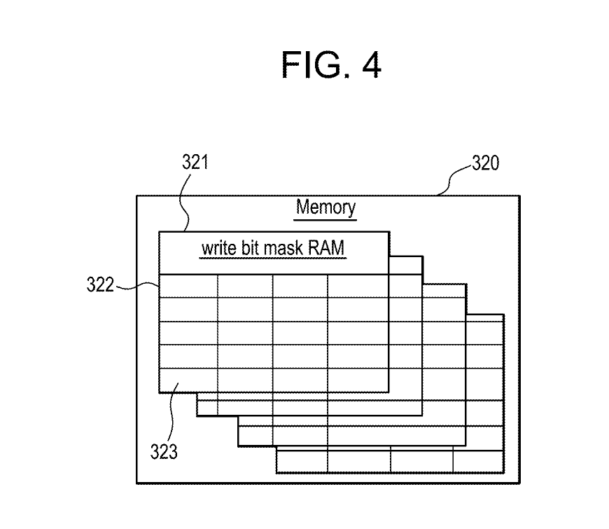

FIGS. 4 and 5 show the memory array 320 in further detail. As shown in FIG. 4, the memory array 320 may include a plurality of RAM modules 321. Each RAM module 321 may include a plurality of rows 322 and a plurality of columns 323. Each of the RAMs 321 may be a nonvolatile flash memory (e.g., NAND flash memory), a dynamic random access memory (DRAM), a static random access memory (SRAM), or any other type of memory that allows for random access to data.

As shown in FIG. 5, each RAM 321 may include a plurality of storage nodes separated into rows R1 to RN and columns C1 to CN. The columns C1 to CN may correspond to a row width of each RAM 321 and each storage node may store one or more elements (e.g., data element or pointer element) of a sequence of data elements that forms a linked list. Each RAM 321 may be fabricated based on design parameters such as an expected size of linked lists to be stored in each RAM 321. For example, a row width of the RAMs 321 may be chosen based on the design parameters which may be a user decision and/or based on empirical data. For example, when designing each RAM 321 for fabrication, the designer may take into account an expected size of linked lists to be stored in the RAMs 321. For example, the system designer may calculate a mean, median, and/or mode of expected sizes of linked lists anticipated to be stored in RAMs 321 and use the result to determine a row width of a RAM 321. It should be understood that each of the RAMs 321 in memory array 320 may have a same number of rows and columns. Alternatively, each of the RAMs 321 may have a different number of rows and columns depending on a desired application.

FIG. 6 shows linked list topographies according to at least one example embodiment. FIG. 6 will be described with reference to FIGS. 1-5.

FIG. 6 shows example topographies for memory rows RN that have row widths equal to CN, and a linked list that has data elements D1 to DN. Although FIG. 6 shows that each data element D1, D2, . . . DN is stored in only one of the storage nodes shown in FIG. 5, it should be understand that each of the storage nodes shown in FIG. 5 may store less than or more than one data element based on the desired application and the storage space in each node.

Topography A in FIG. 6 shows a case where a size of a linked list is less than a row width of row RN. In this case, row RN has empty storage nodes at the end (also referred to as the tail) of the row.

Topography B in FIG. 6 shows a case where a size of a linked list is equal to a row width of row RC. Topography B shows that the number data elements DN in the linked list are equal to a row width of RN. As such, all of the storage nodes in row RN contain a data element.

Topographies C and D show cases where a size of a linked list is greater than a row width of a row RN, and as such, the linked list is stored over multiple rows. Topography C shows a case where a linked list is stored at a same numbered row in different RAMs 321. For example, data elements D1-D8 of the linked list are stored storage nodes in row RN of a first RAM-1 and data elements D9-DN of the linked list are stored in row RN of a second RAM-2. In Topography C, row RN of RAM-1 and row RN of RAM-2 are a same numbered row in each RAM.

Topography D shows a case where a linked list is stored over multiple rows that are not same numbered rows. In this case, a last storage node in row RN may contain a pointer element that links data element DN-1 to a remainder of the linked list stored in a different numbered row of the same RAM. Alternatively, a last storage node in row RN may contain a pointer element that links data element DN-1 to a remainder of the linked list stored in a different numbered row of a different RAM.

In view of FIG. 6 and the above discussion, it should be understood that a row RN contains no more than one pointer element for each linked list stored in the memory array 320. For example, for the linked lists shown in Topographies A-C, no pointer elements are used. Thus, an implementation of a linked list according to at least one example embodiment may allow for increased overall storage capacity of the memory array 320 due to less pointer elements. Another advantage of at least Topographies A-C is that all data elements within a linked list may be accessed (i.e., searched) and/or modified (e.g., data element added to the end of a row) in one clock cycle (or fewer clock cycles compared to conventional systems).

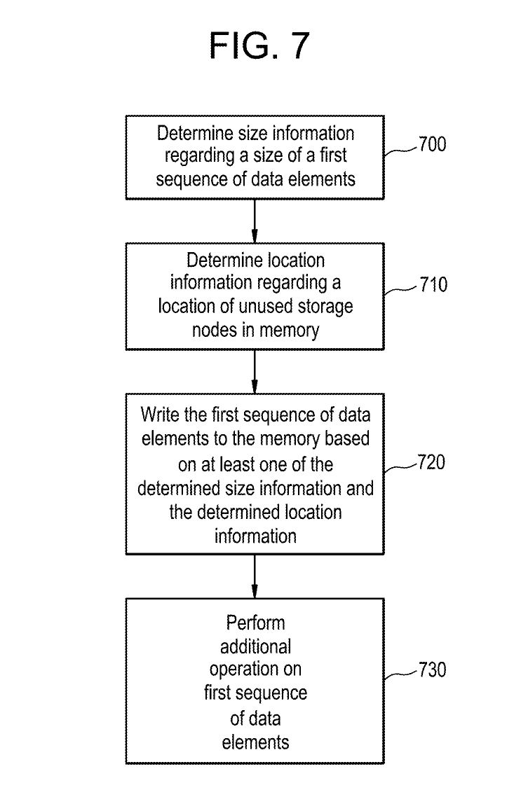

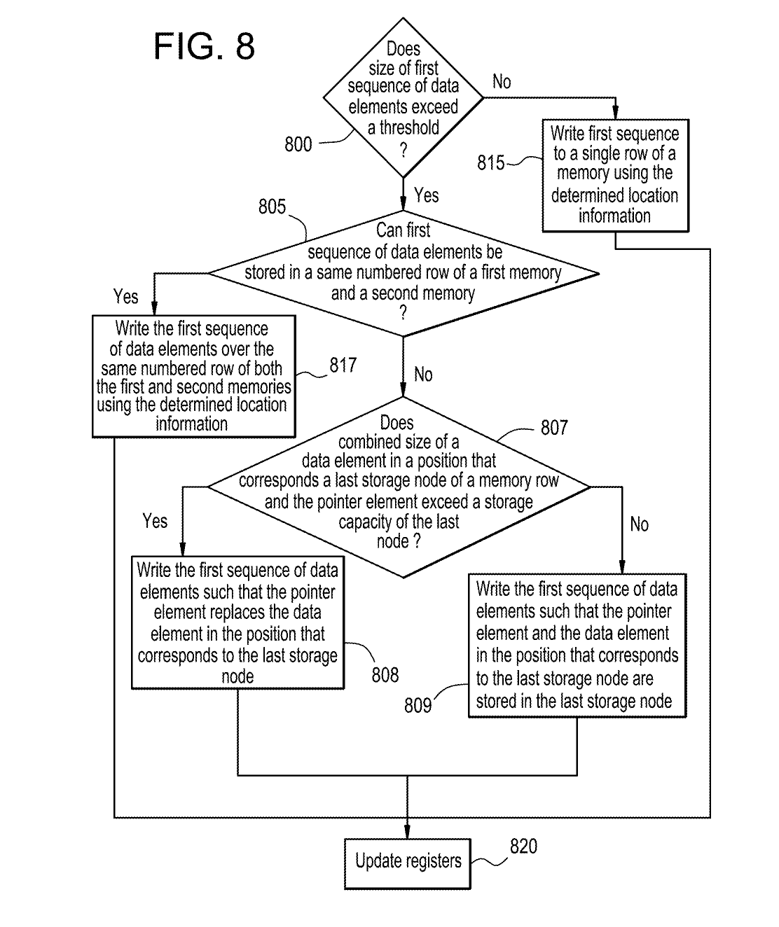

It should be understood that the linked list controller 310 may control the storing of a linked list according to one of the Topographies A-D. The storage operations of the linked list controller 310 that result in one of the Topographies A-D are discussed in more detail with reference to FIGS. 7 and 8.

FIG. 7 is a flow chart illustrating the operation of a linked list controller according to at least one example embodiment. It should be understood that the operations in FIG. 7 may be performed by a processor 311 of the linked list controller 310 in FIG. 3. Thus, FIG. 7 is discussed below with reference to FIG. 3.

As shown in operation 700, the processor 311 may determine size information regarding a size of a first sequence of data elements (e.g., a first linked list) to be stored in memory array 320. For example, each of the data elements may have a known size and the processor 311 may count the number of data elements in the linked list and use the known size of each data element to determine a size of the first sequence of data elements. The determined size may be used as the size information to indicate a size of the first sequence of data elements. The processor 311 may store the determined size information of the first sequence of data elements to register 314.

In operation 710, the processor 311 may determine location information regarding a location of unused storage nodes in at least one of the RAMs 321. The processor may store the determined location information in register 313. The processor 311 may use the determined location information to keep track of unused memory rows and/or unused portions of memory rows in the RAMs 321. The unused rows or unused portions of rows may have been freed by, for example, concatenation of sequences and/or deletion of sequences. In at least one example embodiment, the location information may correspond to information that indicates all unused rows in each RAM 321. The processor 311 may control the register 313 to allocate free memory rows according to FIFO principles. For example, the processor 311 may check the register 313 and retrieve the location of a most recently freed memory row for the storage of the first sequence of data elements.

In operation 720, the processor 311 may write the first sequence of data elements to at least one of the RAMs 321 based on the determined size information and the determined location information. For example, the processor 311 may write the first sequence of data elements to at least one of the rows of the RAMs 321 such that the at least one row contains no more than one pointer element for the first sequence of data elements (see FIG. 6, for example). As noted above, pointer elements are employed in linked lists to link two sequential data elements of a linked list. Operation 720 is described in more detail in the discussion of FIG. 8 below.

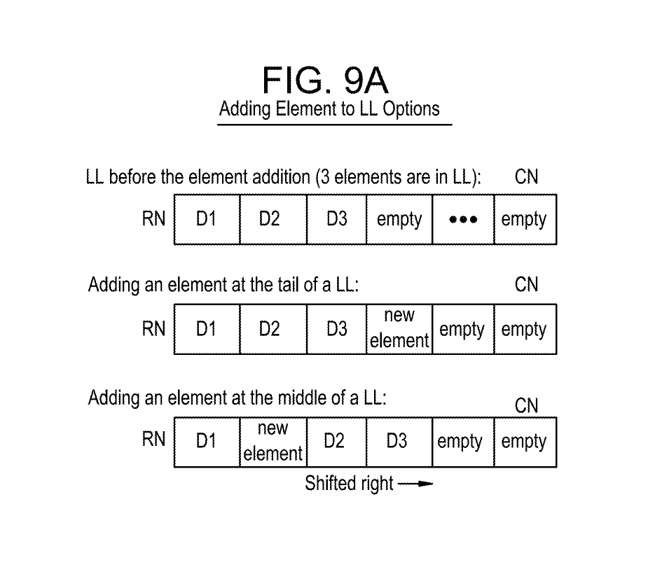

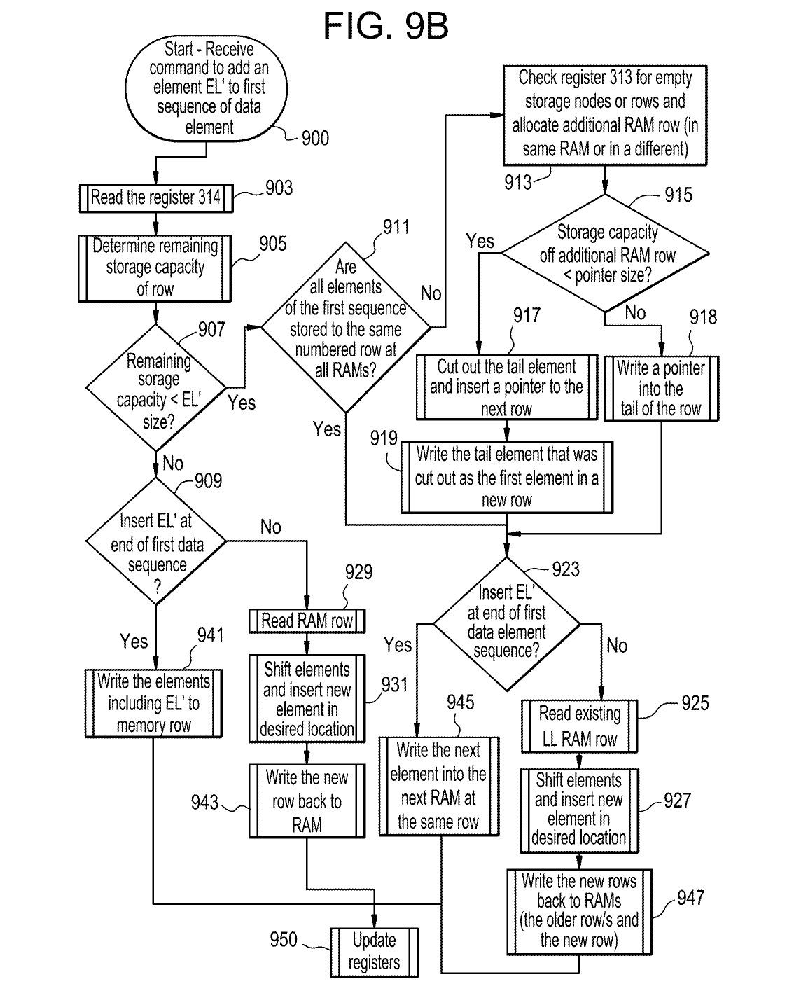

In operation 730, the processor 311 may perform one or more additional operations on the first sequence of data elements that was written into memory in operation 720. For example, the processor 311 may perform a search operation, an insert operation, a delete operation, and/or a concatenation operation on the stored first sequence of data elements. These operations are discussed in more detail with reference to FIGS. 9A-12B.

FIG. 8 is a flow chart illustrating the details of a writing operation according to at least one example embodiment. For example, FIG. 8 shows details of operation 720 from FIG. 7.

In operation 800, the processor 311 checks the size information to determine whether a size of the first sequence of data elements exceeds a threshold associated with a storage capacity of at least one of the rows of one of the RAMs 321. The threshold may be determined by a user of the system or based on empirical data. In one example embodiment, the threshold is a value that indicates a remaining storage capacity of one of the rows in a RAM 321.

In operation 815, if the threshold is not exceeded, then the processor 311 writes the first sequence of data elements to a single row of a RAM 321 according to operation 710. For example, the processor 311 may write the first sequence of data elements to a row of a RAM 321 that the register 313 indicates as being completely empty or partially empty.

The processor 311 performs operation 805 if the processor 311 determines that the threshold is exceeded in operation 800. In operation 805, the processor 311 resolves whether the determined location information from operation 710 indicates that the first sequence of data elements may be stored in a same numbered row of a first memory (e.g., a first RAM 321) and a second memory (e.g., a second RAM 321). For example, the processor 311 checks register 313 to determine whether a same numbered row of the first and second memory is empty. If so, then the processor 311 uses the location information from register 313 to write the first sequence of data elements over a row of the first memory and a row the second memory that corresponds to a same numbered row as the row of the first memory in operation 817 (see, for example, Topography C in FIG. 6).

If not, then the processor 311 proceeds to operation 807, in which the processor 311 determines whether a combined size of a data element in a position in the first sequence that corresponds to a last storage node of a memory row and a size of the pointer element exceed a storage capacity of the last node. If so, then the processor 311 proceeds to operation 808, in which the processor 311 writes the first sequence of data elements such that the pointer element replaces the data element in the position that corresponds to the last storage node (see, for example, Topography D in FIG. 6).

If the processor 311 determines that storage capacity of the last node is not exceeded in operation 807, then the processor 311 performs operation 809. In operation 809, the processor 311 writes the first sequence of data elements such that the pointer element and the data element in the position that corresponds to the last storage node are stored in the last storage node.

In operations 808 and 809, the processor 311 may write the first sequence of data elements to memory rows that the determined location information indicates as being completely empty or partially empty. In at least one example embodiment, the first and second memory rows may be different memory rows of a same RAM 321. In at least one other example embodiment, the first and second memory rows may be differently numbered memory rows in different RAMs 321.

In operation 820, the processor 311 performs an operation that updates registers 313 and 314 with size information and location information of the first sequence of data elements.

As noted above, FIGS. 9A-12B illustrate details of performing one or more additional operations on a sequence of data elements according to at least one example embodiment. For example, the processor 311 may be configured to perform one or more of a search operation, an insert operation, a delete operation, and/or a concatenation operation on a stored sequence of data elements. These operations are discussed in more detail below with reference to FIGS. 9A-12B.

FIG. 9A shows how a data element may be inserted (or added) to a sequence of data elements (e.g., a linked list) already stored on one of the RAMs 321 according to the above description of FIGS. 6-8. With reference to FIG. 9A, for a sequence of three data elements D1, D2, and D3, two examples are shown. In one example, a new data element is added to the end (or tail) of the sequence in row RN. In another example, the new data element is added between elements of the sequence in row RN. FIG. 9A shows adding the new element between data elements D1 and D2 and shifting data elements D2 and D3 to the right.

FIG. 9B is a flow chart illustrating an insert operation according to at least one example embodiment.

In operation 900, the processor 311 receives a command to insert (or add) a data element EL′ to a sequence of data elements (e.g., the first sequence of data elements from FIG. 8).

In operation 903, the processor reads the determined size information of the first sequence of data elements stored in register 314. In operation 905, the processor 311 determines a remaining storage capacity of a row (or rows) in which the first sequence of data elements is stored based on the determined size information read in operation 903. For example, the processor 311 may compare the determined size information to a known row width of the memory row to determine a remaining number of empty storage nodes in the row (or rows) containing the first sequence of data elements.

Then, the processor 311 may generate a modified sequence of data elements by inserting the data element EL′ into a desired location of the first sequence of data elements based on the determined remaining storage capacity. As shown in FIG. 9B, generating a modified sequence of data elements may encompass multiple operations 907-931, which are described in more detail below.

After generating the modified sequence of data elements, the processor 311 may write the modified sequence of data elements (now containing data element EL′) to one or more RAMs 321. As shown in FIG. 9B, this writing operation may encompass multiple operations 941-947, which are described in more detail below.

In operation 950, the processor 311 updates registers 313 and 314 with size information and location information for the modified sequence of data elements written to memory.

As noted above, generating a modified sequence of data elements and writing the modified sequence of data elements may encompass multiple operations 907-931 and operation 941-947, respectively. These operations are discussed below.

After the processor 311 determines a remaining storage capacity of a row (or rows) on which the first sequence of data elements is stored in operation 905, the processor 311 may determine whether the remaining storage capacity is less than a size of data element EL′. If not, then the processor 311 determines whether data element EL′ is to be inserted a tail (or end) of the first sequence of data elements in operation 909. If so, then the processor 311 generates a modified sequence of data elements that includes data element EL′ inserted at the end of the first sequence and writes the modified sequence to a memory row of a RAM 321. For example, in operation 941, the processor 311 writes the data element EL′ to the end of the first sequence by, for example, employing a write-mask that masks off existing data elements in the first sequence already stored in the memory row so as to avoid altering these data elements. Writing the first sequence using a write-mask may also improve a speed of the insert operation by avoiding a time consuming read-modify-write operation.

If in operation 909, the processor 311 determines that the data element EL′ is not to be inserted at the end of the first data sequence, then the processor 311 may perform a read/modify/write operation, referred to as operations 929, 931, and 943. For example, the processor may read the row (or rows) containing the first data sequence in operation 929 (to a buffer memory, for example), generate a modified sequence of data elements by shifting existing data elements and inserting data element EL′ in a desired location in operation 931, and write the generated modified sequence back to the memory row (or rows) in operation 943.

Returning to operation 907, if the remaining storage capacity of a memory row (or rows) containing the first sequence of data elements is less than the data element size EL′, then the processor 311 determines whether all data elements of the first sequence are stored to a same numbered row in RAMs 321 in operation 911. If not, then the processor 311 performs operations 913-921 prior to operation 923. If so, then the processor 311 performs operation 923 without performing operations 913-921.

In operation 913, the processor 311 checks register 313 for empty storage nodes (or empty rows) and allocates an additional RAM row for the storage of the modified sequence of data elements. It should be understood that this additional RAM row may be in a same or different RAM as the RAM currently storing the first sequence of data elements (such as in Topographies C and D in FIG. 6).

In operation 915, the processor 311 determines whether a storage capacity of the memory row allocated in operation 913 is less than a size of a pointer element. If so, the processor 311 performs operation 917 in which the pointer element is inserted by replacing a data element in a last one of the storage nodes of the row with the pointer element. In operation 919, the processor 311 may write the replaced data element to a storage node (e.g., a first storage node) in a new memory row. If the remaining storage capacity of the memory row allocated in operation 913 is greater than a size of a pointer element, then the processor 311 performs operation 918 in which the pointer element is inserted by adding the pointer element to a data element in a last storage node of the row such that the last storage element contains the data element and the pointer element.

In operation 923, the processor 311 determines whether the data element EL′ is to be inserted at the end of the first sequence of data elements. If so, then in operation 945, the processor 311 writes the next data element to a new memory row (e.g., a new memory row of a same RAM or a same numbered memory row of a different RAM). If not, then the processor 311 performs a read/modify/write process in operations 925, 927, and 947. For example, the processor may read the row (or rows) containing the first data sequence in operation 925, generate a modified sequence of data elements by shifting existing data elements and inserting data element EL′ in a desired location in operation 927, and write the generated modified sequence back to the memory row (or rows) in operation 947. It should be understood that operation 947 may write the modified sequence of data elements to a memory row (or rows) where the first sequence of data elements was originally stored and to any additional memory rows allocated in operations 911 and 913.

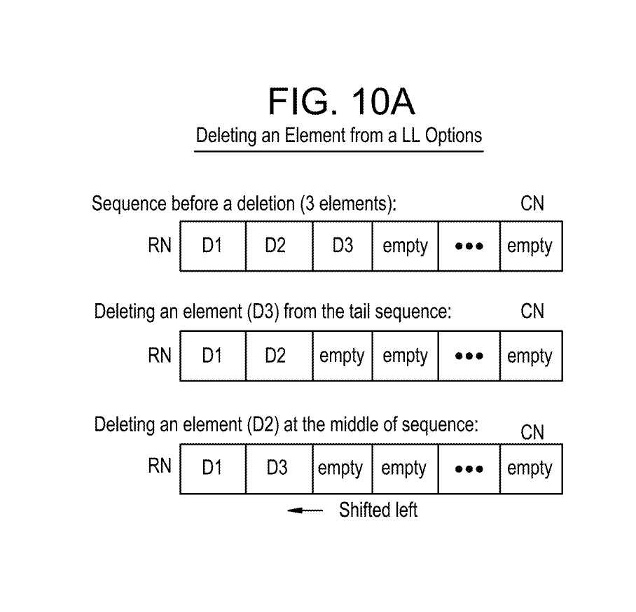

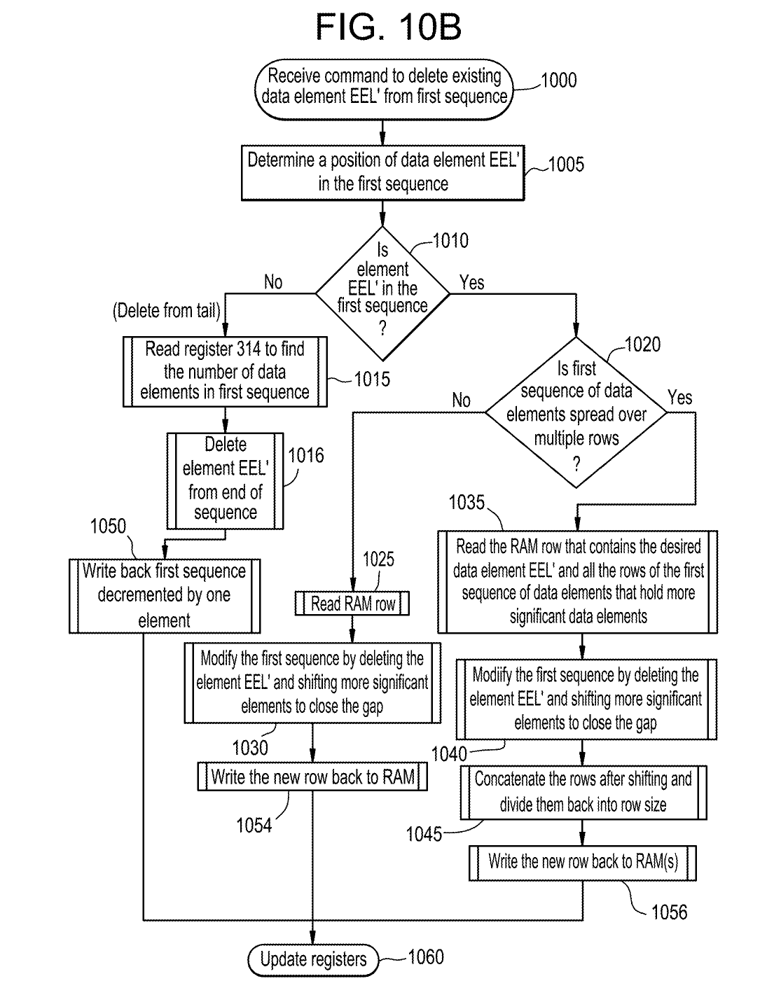

FIGS. 10A and 10B illustrate a delete operation according to at least one example embodiment.

FIG. 10A shows how a data element may be deleted (or removed) from a sequence of data elements (e.g., a linked list) already stored on one of the RAMs 321 according to the above description of FIGS. 6-8. With reference to FIG. 10A, for a sequence of three data elements D1, D2, and D3, two examples are shown. In one example, an existing data element D3 is deleted from the end (or tail) of the sequence in row RN. In another example, an existing data element D2 is deleted between elements D1 and D3 of the sequence in row RN. FIG. 10A shows deleting element D2 from the sequence and shifting element D3 to the left to form a modified sequence of D1, D3.

FIG. 10B is a flow chart illustrating a delete operation according to at least one example embodiment.

In operation 1000, the processor 311 receives a command to delete an existing data element EEL′ from a sequence of data elements (e.g., the first sequence of data elements from FIG. 8).

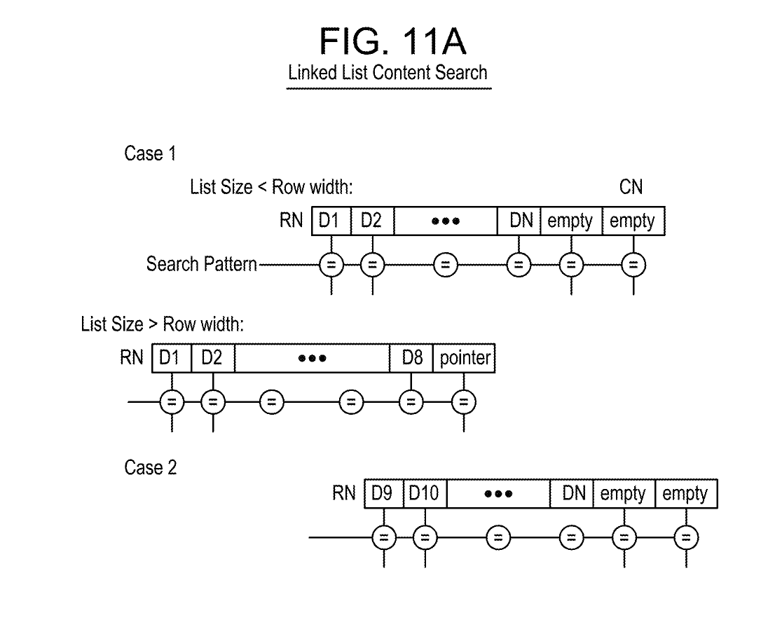

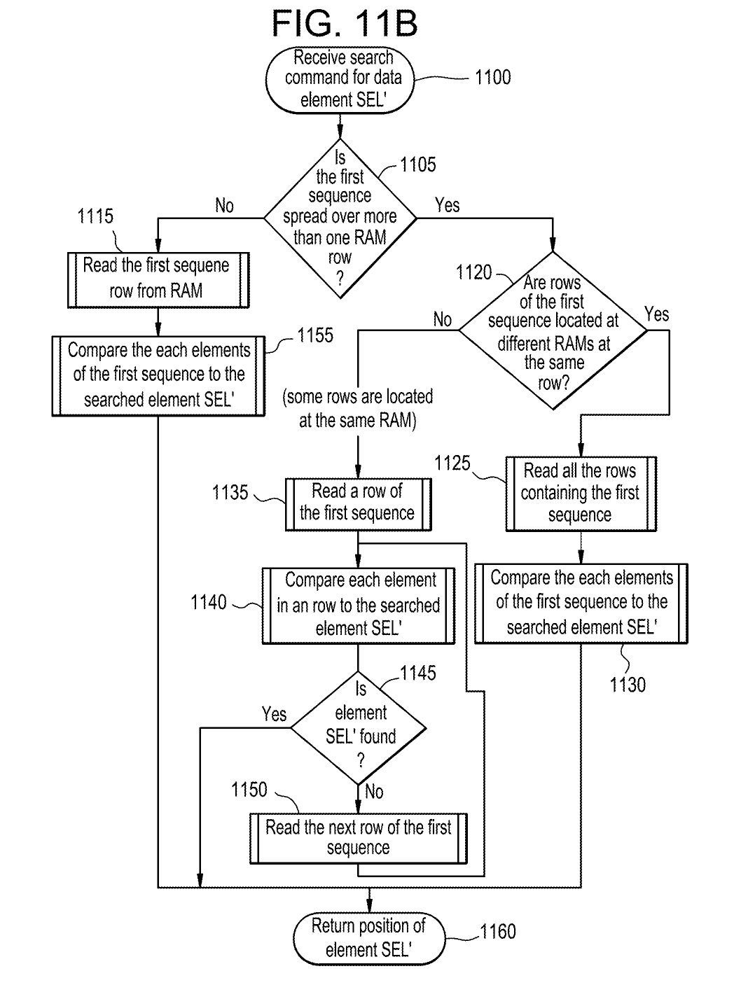

In operation 1005, the processor 311 determines a position of the data element EEL′ within the first sequence of data elements. For example, the processor 311 performs a search operation on the first sequence of data elements (see, for example, FIGS. 11A and 11B for details regarding the search operation).

Then, the processor 311 generates a modified sequence of data elements by deleting the existing data element EEL′ from the first sequence based on the determined position. After generating the modified sequence of data elements, the processor 311 writes the modified sequence of data elements to a memory row (or rows) in one or more of RAMs 321. In operation 1060, the processor 311 updates registers 313 and 314 with size information and location information of the modified sequence of data elements. For example, the processor subtracts a size of data element EEL′ from an overall size of the first sequence of data elements and stores the result as size information in register 314.

As shown in FIG. 9B, generating a modified sequence of data elements and writing the modified sequence may include multiple operations 1010-1045 and 1052-1056, respectively. These operations are described in more detail below.

In operation 1010, the processor 311 determines whether data element EEL′ is at the end (or tail) of the first sequence of data elements. If not, then the processor 311 reads the size information of the first sequence of data elements from register 314 to determine a number of data elements in the first sequence. In operation 1016, the processor 311 deletes data element EEL′ from the end of the first sequence to generate a modified sequence of data elements. In operation 1050, the processor 311 writes the modified sequence of data elements back to a RAM 321 from which the original sequence was read. If in operation 101, the processor 311 determines that element EEL′ is not and the end (or tail) of the first sequence of data elements, then the processor 311 proceeds to operation 1020.

In operation 1020, the processor 311 determines whether the first sequence of data elements is spread over multiple memory rows. If not, then the processor 311 performs a read/modify/write operation in operations 1025, 1030 and 1054. For example, the processor 311 may read the first sequence of data elements from the appropriate memory row in operation 1025 (to a buffer memory, for example), modify the first sequence of data elements by removing element EEL′ and shifting the more significant data elements to the left in operation 1030 (see FIG. 10A), and write the modified sequence of data elements back to the memory row from which the first sequence of data elements was read in operation 1054.

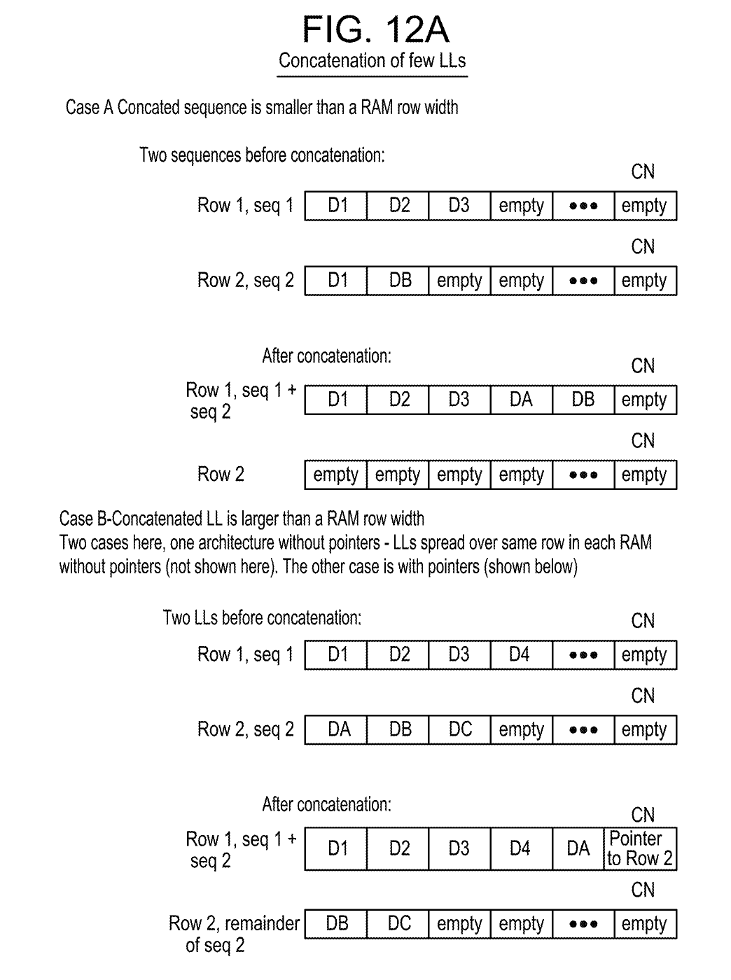

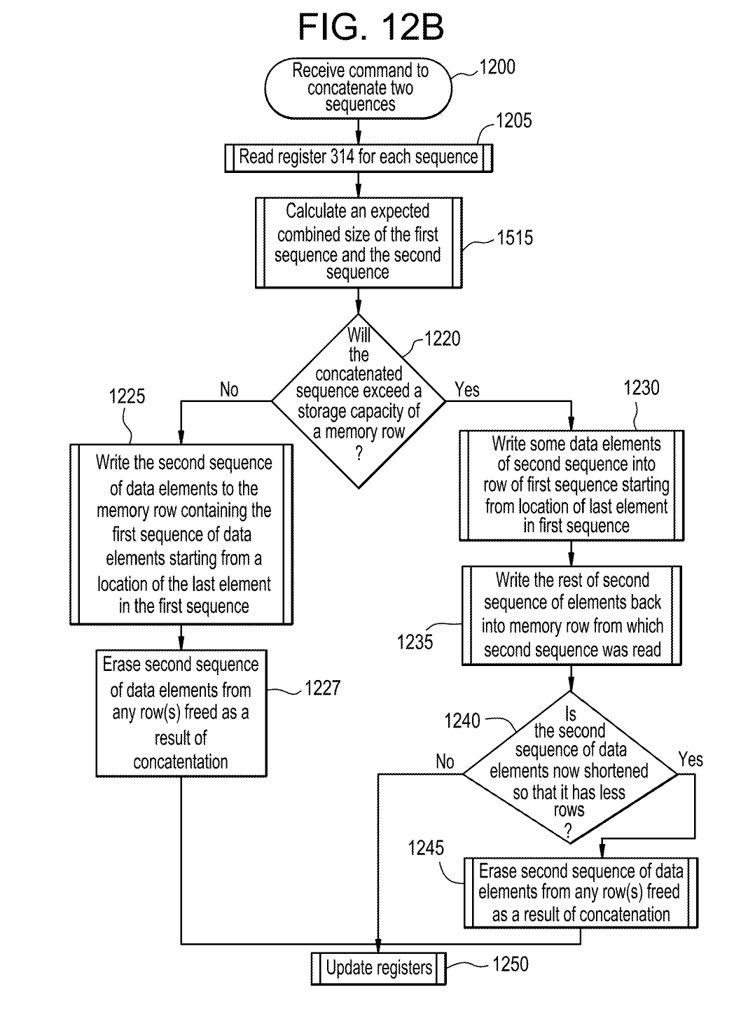

If, in operation 1020, the processor 311 determines that the first sequence of data elements is spread over multiple memory rows, then the processor 311 proceeds to a read/modify/write operation in operations 1035, 1040, 1045, and 1057. In operation 1035, the processor 311 may read the memory row that contains the data element EEL′ and all memory rows that hold more significant data elements. In operation 1040, the processor 311 may modify the first sequence of data elements by deleting data element EEL′ and shifting more significant data elements to the left. In operation 1045, the processor 311 may further modify the first sequence by concatenating the rows read in operation 1035. The concatenation operation is discussed in further detail below with reference to FIGS. 12A and 12B. In operation 1057, the processor 311 may write modified sequence of data elements (now excluding data element EEL′) back to memory rows from which the first sequence was read.

FIGS. 11A and 11B illustrate a search operation according to at least one example embodiment.

It should be understood that each of the RAMs 321 may be a content addressable memory. Accordingly, FIG. 11A shows a searching operation for two cases: 1) where a size of a sequence of data elements (e.g., linked list) is less than a row width of row RN; and 2) where the size of the sequence of data elements is greater than a row width of row RN. In both cases 1 and 2, a desired data element SEL′ may be searched by comparing each data element in the sequence D1 to DN to the desired data element SEL′ to find a matching data element(s). However, in case 2, the sequence of data elements D1 to DN is stored over multiple memory rows either in the same RAM 321 or different RAMs 321. Here, it should be understood that if the sequence of data elements D1 to DN in case 2 is stored over same numbered rows within different RAMs 321, then the search operation may be carried out simultaneously on the same numbered rows. This allows for the search operation to be completed within one clock cycle of a processor (e.g., processor 311), thereby improving a speed of the memory system compared to conventional memory data structures that take more than one clock cycle to search for a desired data element.

FIG. 11B illustrates a flow chart for performing the search operation according to at least one example embodiment.

In operation 1100, the processor 311 receives a search command (or instruction) from, for example, the host 100 to search for data element SEL′. In operation 1105, the processor 311 determines whether a sequence of data elements (e.g., the first sequence of data elements from FIG. 8) is stored over multiple memory rows of a RAM or RAMs 321. If not, then the processor 311 reads the first sequence of data elements from a row of a RAM 321 in operation 1115, and compares each data element in the first sequence to data element SEL′ to find matching data elements in operation 1155. In operation 1160, the processor 311 returns a position(s) of a matching data element(s) to the host 100.

It should be understood that the processor 311 may perform operation 1105 using size information from register 314 and the row width of the row storing the first sequence of data elements. Alternatively, the processor 311 may consult some other register that contains indicates whether the first sequence of data elements is stored over multiple memory rows.

If, in operation 1105, the processor 311 determines that the first sequence of data elements is spread over multiple rows, then the processor 311 performs operation 1120. In operation 1120, the processor 311 determines whether the multiple rows are located in different RAMs 321. If so, then the processor 311 reads all rows containing the first sequence of data elements in operation 1125, compares each data element in the first sequence to data element SEL′ in operation 1130 to find a matching data element(s), and returns a position(s) of the matching data element(s) to the host 100. If not, then the processor 311 performs operation 1135 by reading a row of the first sequence from one RAM 321. In operation 1140, the processor 311 compares each data element in the row to data element SEL′, and determines whether a matching data element is found in operation 1145. If not, then the processor 311 reads a next row containing the first sequence in operation 1150 and again performs operations 1140 and 1145. Once a matching data element(s) is found in operations 1145 and 1150, then the processor 311 may return a position of the matching data element to host 100 in operation 1160. The processor 311 may store an address of the returned position (in register 314 or some other register) for use in future operations.

FIGS. 12A and 12B illustrate a concatenation operation according to at least one example embodiment.

FIG. 12A shows two example cases for concatenating a sequence of data elements (e.g., the first sequence of data elements in FIG. 8) with another sequence of data elements (referred to as a second sequence of data elements). Case A shows an example where a size of a concatenated sequence is less than a row width of a memory row in one of RAMs 321. For example, before concatenation, row 1 contains the first sequence of data elements D1, D2, and D3 and row 2 contains a second sequence of data elements DA and DB. As shown in FIG. 12A, the concatenated sequence D1, D2, D3, DA, and DB fits within a single memory row (row 1), which frees up memory row 2.

Case B shows an example where a size of a concatenated sequence is greater than a row width of a memory row in one of RAMs 321. For example, before concatenation, row 1 contains a first sequence of data elements D1, D2, D3, and D4 and row 2 contains a second sequence of data elements DA, DB, and DC. As shown in Case B, the concatenated sequence D1, D2, D3, D4, DA, DB, and DC does not fit within a single memory row. Accordingly, a pointer element is inserted in a last storage node of row 1 to link rows 1 and 2. The pointer element may be inserted according to the operations described above with reference to FIG. 8.

It should be understood that the first and second sequences of data elements discussed above with reference to FIG. 12A may be stored in memory rows of a same RAM 321 or memory rows of different RAMs 321. Although not explicitly shown in FIG. 12A, it should also be understood that if the first and second sequences of data elements are stored on same numbered rows of different RAMs 321, then the pointer element in Case B may be omitted as in Topography C from FIG. 6.

FIG. 12B is a flow chart illustrating details of a concatenation operation according to at least one example embodiment.

In operation 1200, the processor 311 receives a command from, for example, the host 100 to perform a concatenate operation. For example, the processor 311 may receive a command to modify the first sequence of data elements from FIG. 8 by concatenating the first sequence of data elements with a second sequence of data elements (also stored to a RAM 321 by the operations in FIG. 8).

In operation 1205, the processor 311 reads register 314 to determine the size and content of each sequence of data elements. In operation 1215, the processor 311 calculates an expected combined size of the first sequence and the second sequence as a concatenated sequence of data elements using the determined sizes read register 314 by, for example, adding the size of the first sequence and the size of the second sequence.

Operations 1220-1250 describe how the processor 311 writes the concatenated sequence to one or more memory rows based on the calculated combined size. In operation 1220, the processor 311 determines whether calculated combined size of the concatenated sequence of data elements exceeds a storage capacity of a memory row (e.g., the memory row containing the first sequence of data elements). If not, then the processor 311 proceeds to operation 1225 and writes the second sequence of data elements to the memory row containing the first sequence of data elements starting from a location of the last data element in the first sequence (see Case A in FIG. 12A). For example, the processor 311 may write the second sequence using a write-mask to mask off the data elements of the first sequence so as to avoid altering the first sequence and to improve a speed of the operation. In operation 1227, the processor 311 erases any data elements of the second sequence that are in rows freed by the concatenation operation.

If, in operation 1220, the processor 311 determines that the combined size of the concatenated sequence of data elements exceeds a storage capacity of a memory row (e.g., the memory row containing the first sequence of data elements), then the processor proceeds to operation 1230. In operation 1230, the processor 311 writes some data elements of the second sequence into a memory row of the first sequence starting from a location of the last data element in the first sequence. For example the processor 311 may write some of the data elements of the second sequence to the memory row containing the first sequence using a write-mask to mask off data elements of the first sequence to avoid altering the first sequence and to improve a speed of the operation.

In operation 1235, the processor 311 writes remaining data elements of the second sequence (i.e., those data elements not written in operation 1230) back to the memory row from which the second sequence was read (see Case B in FIG. 12A). In operation 1240, the processor 311 determines whether operations 1230 and 1235 were performed such that the number of memory rows containing the second sequence of data elements decreases. If so, then the processor 311 erases any data elements of the second sequence that are in rows freed by the concatenation operation in operation 1245.

In operation 1250, the processor 311 updates the registers 313 and 314. For example, after operation 1225, the processor 311 may update register 313 to reflect the size of the concatenated sequence and update register 314 to reflect how the content of storage nodes in each memory row has changed. For example, if any memory rows were freed by the concatenation operation, then the processor 311 stores a location of these free rows in register 313.

In view of the foregoing description, it should be understood that a device to at least one example embodiment may provide an advantageous data architecture for linked lists. For example, a device according to at least one example embodiment may provide for improved storage capacity by reducing the number of pointer elements used for storing linked lists. Further, a device according to at least one example embodiment may improve the speed at which linked list operations are performed by allowing for the operations to be performed in fewer clock cycles as a result of the manner in which the linked is stored. The improved speed may be a result of storing the linked list according to one of the above described topographies and/or using a write-mask when possible.

The foregoing description of example embodiments has been provided for purposes of illustration and description. It is not intended to be exhaustive or limiting. Individual elements or features of a particular example embodiment are generally not limited to that particular example embodiment. Rather, where applicable, individual elements or features are interchangeable and may be used in a selected example embodiment, even if not specifically shown or described. The same may also be varied in many ways. All such modifications are intended to be included within the scope of this disclosure.

What is claimed is:

1. A device, comprising:
at least one memory including plurality of storage nodes arranged into a plurality of rows, each of the rows having a known row width; and
a controller configured to,
determine size information regarding a size of at least a first sequence of data elements,
determine location information regarding a location of unused storage nodes in the at least one memory, and
write the first sequence of data elements to at least a first row of the at least one memory based on at least one of the determined size information and the determined location information such that the first row contains no more than one pointer element for the first sequence of data elements, the pointer element linking two sequential data elements.

2. The device of claim 1, wherein the determined location information indicates that the first row is unused.

3. The device of claim 1, wherein, if the determined size information indicates that a size of the first sequence of data elements exceeds a threshold associated with a storage capacity of the first row, then the controller is configured to write data elements of the first sequence that precede the pointer element and the pointer element to the first row and write remaining data elements of the first sequence that follow the pointer to a second row of the at least one memory.

4. The device of claim 3, wherein the determined location information indicates that the first row and the second row are unused.

5. The device of claim 1, wherein,
the at least one memory includes a first memory and a second memory, the first memory having the first row, and,
if the determined size information indicates that a size of the first sequence of data elements exceeds a threshold associated with a storage capacity of the first row of the first memory, the controller is configured to write data elements of the first sequence that precede the pointer element and the pointer element to the first row of the first memory and write remaining data elements of the first sequence that follow the pointer to the second memory.

6. The device of claim 5, wherein the controller is configured to write the remaining data elements of the first sequence to a row the second memory that corresponds to a same numbered row as the row of the first memory.

7. The device of claim 6, wherein the first memory and the second memory have different known row widths.

8. The device of claim 1, wherein the at least one memory includes a first memory and a second memory, the first memory having the first row and,
if the determined size information indicates that a size of the first sequence of data elements exceeds a threshold associated with a storage capacity of the first row of the first memory, the controller is configured to write the first sequence of data elements over a row of the first memory and a row the second memory that corresponds to a same numbered row as the row of the first memory without the use of the pointer element.

9. The device of claim 1, wherein the controller is configured to perform at least one of a read operation and a search operation related to the first sequence of data elements in a single clock cycle.

10. The device of claim 9, wherein, in order to perform the search operation for a desired data element in the first sequence, the controller is configured to,
determine whether the first sequence of data elements is stored over multiple rows of the at least one memory based on the determined size information and a known row width of the least one memory,
read at least some of the data elements of the first sequence from at least one of the rows,
compare the desired element to each of the read data elements, and
return a position of the desired element in the first sequence based on the comparison.

11. The device of claim 1, wherein the at least one memory is at least one random access memory.

12. The device of claim 1, further comprising:
a first register; and
a second register, wherein the controller is configured to,
store the determined size information for at least the first sequence in the first register, and
store the determined location information in the second register.

13. The device of claim 12, wherein the controller is configured to modify the first sequence of data elements by at least one of inserting an additional data element, deleting an existing data element, and concatenating the first sequence of data elements with a second sequence of data elements.

14. The device of claim 13, wherein, in order to modify the first sequence of data elements by inserting the additional data element, the controller is configured to,
read the determined size information stored in the first register,
determine a remaining storage capacity of the at least one row based on the determined size information read from the first register,
generate a modified sequence of data elements by inserting the additional data element into a desired location of the first sequence of data elements based on the determined remaining storage capacity, and
write the modified sequence of data elements to the at least one row.

15. The device of claim 14, wherein the controller is configured to update the first register with size information of the modified sequence.

16. The device of claim 13, wherein, in order to modify the first sequence of data elements by deleting the existing data element, the controller is configured to,
determine a position of the existing data element in the first sequence,
generate a modified sequence of data elements by deleting the existing data element from the first sequence based on the determined position, and
write the modified sequence of data elements to the at least one row.

17. The device of claim 16, wherein the controller is configured to update the first register based on size information of the modified sequence.

18. The device of claim 13, wherein the controller is configured to store size information of a second sequence of data elements in the first register, and in order to modify the first sequence of data elements by concatenating the first sequence of data elements with the second sequence of data elements, the controller is configured to,
read the size information for each of the first sequence of data elements and the second sequence of data elements from the first register,
calculate a combined size of the first sequence and the second sequence as a concatenated sequence of data elements using the size information read from the first register, and
write the concatenated sequence of data elements to the at least one row based on the calculated combined size.

19. A method for the device of claim 1, the method comprising:
fabricating the at least one memory based on design parameters; and
instructing the controller to,
determine the size information,
determine the location information, and
write the first sequence of data elements to at least the first row of the at least one memory.

20. A system, comprising:
a host;
a system bus; and
a device configured to communicate with the host via the system bus, the device including,
at least one memory including plurality of storage nodes arranged into a plurality of rows, each of the rows having a known row width, and
a controller configured to,
determine size information regarding a size of at least a first sequence of data elements,
determine location information regarding a location of unused storage nodes in the at least one memory, and
write the first sequence of data elements to at least a first row of the at least one memory based on at least one of the determined size information and the determined location information such that the first row contains no more than one pointer element for the first sequence of data elements, the pointer element linking two sequential data elements.
